(19) United States
(12) Patent Application Publication
(10) Pub. No.: US 2005/0134586 A1
(43) Pub. Date: Jun. 23, 2005

(54) Method for generating 3D mesh from 3D points by using shrink-wrapping scheme of boundary cells

(76) Inventors: Bon Ki Koo, Taejon (KR); Chang Woo Chu, Taejon (KR); Jae Chul Kim, Taejon (KR); Byoung Tae Choi, Taejon (KR); Young Kyu Choi, Cheonan (KR)

Correspondence Address: JACOBSON, PRICE, HOLMAN & STERN;PROFESSIONAL LIMITED LIABILITY COMPANY, 400 Seventh Street, N.W., Washington, DC, 20004, US

(21) Appl. No.: 10/831,153

(22) Filed: Apr. 26, 2004

(30) Foreign Application Priority Data
Dec. 23, 2003 (KR) 2003-95254

(51) Int. Cl. G06T 17/20

(52) U.S. Cl. 345/423

(57) ABSTRACT

The present invention relates to a method for generating a mesh model representing a 3D surface from unorganized 3D points extracted from a 3D scanner by using a shrink-wrapping scheme of boundary cells. A method for generating 3-dimensional mesh according to the present invention comprises the steps of: (a) receiving unorganized 3D point coordinates extracted by a 3D scanner or a digitizer; (b) extracting a minimum bounding box including all the point coordinates and uniformly dividing the extracted bounding box into cells of a predetermined size; (c) extracting a boundary cell including at least one point from the cells, extracting a boundary surface from all the boundary cells, and generating an initial mesh by summing extracted boundary surfaces; (d) calculating distances between each vertex constituting the mesh and the several points, finding a nearest point, and moving the vertex to the nearest point; and (e) averaging location of each shrink-wrapped vertex and location of the neighboring vertexes, and moving the shrink-wrapped vertex to center of neighboring vertexes.

### BACKGROUND OF THE INVENTION

1. Field of the Invention

The present invention relates to a method for generating a 3-dimensional (hereinafter, referred to as 3D) mesh, and more particularly, to a method for generating a mesh model representing a 3D surface from unorganized 3D points extracted from a 3D scanner by using a shrink-wrapping scheme of boundary cells.

2. Description of the Related Art

The unorganized 3D points do not mean a case in which there is a specific relation between points as range image or contour, but mean a case in which there is not any relation with points as the 3D points data extracted by a 3D digitizer. If a point has a specific relation with points as a range image or a contour, a surface mesh approximating the points can be created using the relation between the points. Currently, various methods have been suggested. In general, it is, however, difficult to obtain a stable model in constituting a 3D surface from the unorganized 3D points since no information on the shape of an object can be obtained except for coordinates of the 3D points.

Several methods have been suggested. In the paper “Surface reconstruction from unorganized points”, Siggraph, Vol. 26, No. 2, pp. 71 - 78, July 1992, H. Hoppe, et al, discloses a method that includes of the steps of obtaining several points nearest to an arbitrary point, estimating a normal direction of each points, calculating coded distance, applying a modified marching cube algorithm with using the distance, and extracting a surface mesh. A 3D mesh regeneration method of a cube shrink-wrapping scheme includes the steps of obtaining bounding box including all the points, uniformly dividing the six faces bounding box in a predetermined precision, defining the divided six faces as an initial mesh, and continually shrink-wrapping the mesh to the point direction so as to obtain a surface mesh of an object.

The conventional 3D mesh generation method of a cube shrink-wrapping scheme will be described referring to FIG. 1.

FIG. 1 is a flowchart of a 3D mesh generation method of cube shrink-wrapping scheme according to the related art.

As shown in FIG. 1, when mesh generation method starts, unorganized 3D coordinates extracted by a 3D scanner or a digitizer is inputted (101). A minimum bounding box including all the points is extracted (102). The extracted bounding box has six rectangular faces, and the six rectangular faces are divided into pieces of a predetermined size (103). Here, the division precision is properly chosen according to the size and the complexity of an object. The divided faces become a closed face having a predetermined volume, and a point approximating an object to be represented on the face is obtained to generate an initial mesh (104).

Next, continual shrink-wrapping process 105 and smoothing process 106 are performed. In other words, distances between each vertex constituting a current mesh and all the points are calculated to find the nearest point, and each vertex is moved to the nearest point (105). The vertex is moved to the substantially center of a line from the original vertex to the nearest point. Since the process in which the vertexes of the mesh are moved to near points makes the vertexes placed to one side, a mesh smoothing process is performed (106). In the mesh smoothing process, the location of each shrink-wrapped vertex and locations of neighboring vertexes are averaged to move the vertex to the center of the neighboring vertexes as possible. So, the phenomenon is relieved that the vertexes get partially together to one point. After the shrink-wrapping process and the smoothing process are repeated as many as a predetermined number by the determination step 107 of repeating the processes, 3D mesh whose shape approximates to the surface of an object is generated (108). Then, the mesh generation method is completed.

However, fundamentally, the conventional mesh generation method can be applied to a spherical shape, but cannot be applied to the case in which an object has a hall as a doughnut. In the process to find the point nearest to each vertex of the initial mesh, all the distances between one vertex and all the points should be measured so that it takes a long-term period to process.

### SUMMARY OF THE INVENTION

Accordingly, the present invention is directed to a method for generating a mesh model representing a 3D surface from unorganized 3D points extracted from a 3D scanner by using a shrink-wrapping scheme of boundary cells, which substantially obviates one or more problems due to limitations and disadvantages of the related art.

It is an object of the present -invention to provide a method for generating a 3D mesh in which original object surface is stably approximated from 3D points extracted from an object of a predetermined topology and the elapsed time for surface modeling can be reduced.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for generating 3-dimensional mesh, comprising the steps of: (a) receiving unorganized 3D point coordinates extracted by a 3D scanner or a digitizer; (b) extracting a minimum bounding box including all the point coordinates and uniformly dividing the extracted bounding box into cells of a predetermined size; (c) extracting a boundary cell including at least one point from the cells, extracting a boundary surface from all the boundary cells, and generating an initial mesh by summing extracted boundary surfaces; (d) calculating distances between each vertex constituting the mesh and the several points, finding a nearest point, and moving the vertex to the nearest point; and (e) averaging location of each shrink-wrapped vertex and location of the neighboring vertexes, and moving the shrink-wrapped vertex to center of neighboring vertexes.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a flowchart of a 3D mesh generation method of cube shrink-wrapping scheme according to the related art; and

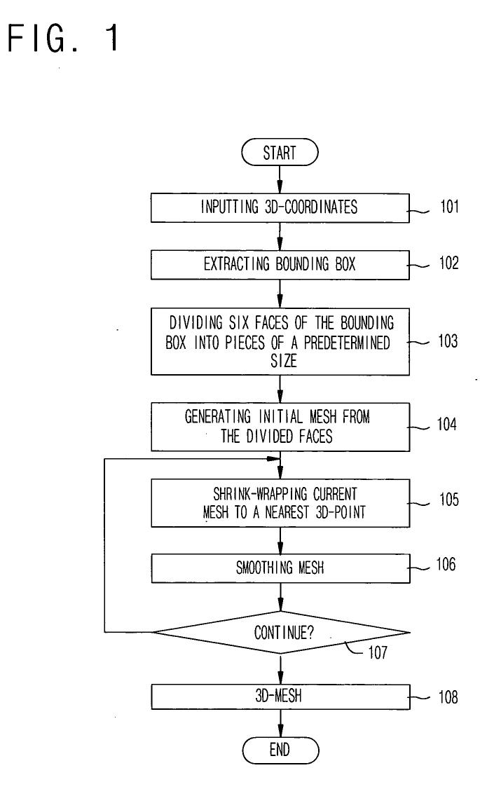

FIG. 2 is a flowchart of a method for generating a 3D mesh from 3D points by using a shrink-wrapping scheme of boundary cells according to the present invention.

### DETAILED DESCRIPTION OF THE INVENTION

Reference will now be made in detail to the preferred embodiments of the present invention, examples of which are illustrated in the accompanying drawings.

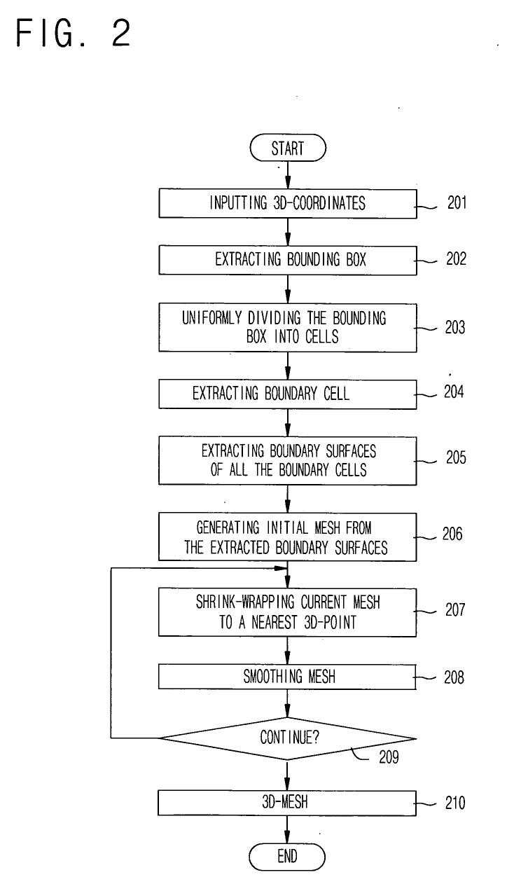

FIG. 2 is a flowchart of a method for generating a 3D mesh from 3D points by using a shrink-wrapping scheme of boundary cells according to an embodiment of the-present invention.

When 3D mesh generation method starts, unorganized 3D coordinates extracted by a 3D scanner or a digitizer is inputted (201). A minimum bounding box including all the points is extracted (202). To extract the bounding box, the maximum and minimum values maxₓ, minₓ, max_{y}, min_{y}, max_{z}, and min_{z} is obtained with respect to all the inputted 3D coordinates in the directions x, y and z. A bounding box is extracted using six faces (x=minₓ, x=maxₓ, etc. 2 faces in the direction of each coordinate) according to equation 1.
minₓ<x<maxₓ
min_{y}<y<max_{y}
min_{z}<z <max_{z} Equation 1

Then, the extracted box is uniformly divided into cells of a predetermined size (203). To divide a space, a set of faces orthogonal to each other in three directions should be used. For example, division in x-direction will be described. When division is performed with precision n, a space between maximum maxₓ and minimum minₓ in the x-direction can be divided into nₓ pieces. In other words, i-th x-coordinate xᵢ can be calculated as Equation 2.

$${x}_{i} = {min}_{x} + \frac{{max}_{x} - {min}_{x}}{{n}_{x}} i , i = 0 , 1 , … , {n}_{x} \qquad Equation 2$$

If the x-coordinate axis is divided into nₓ pieces, the bounding box is divided into nₓ pieces by nₓ+1 planes x=xᵢ, i=0, 1, . . . , nₓ. If the divided space is divided into n_{y} and n_{z} pieces in y-axis and z-axis respectively in the same way, the original bounding box is converted into a set of nₓ×n_{y}×n_{z} cells. Here, the division precision should be proportional to precision of points. If the points are distributed very closely, the size of the cell is reduced (the precision n is increased) to make a more precise surface. If the bounding box including points is uniformly divided into cells, the original space becomes the sum of a multiplicity of cells. In an arbitrary cell space, at least one point may be included or not. Here, the cell that does not include a point is defined as an outer cell. The outer cells are somewhat spaced from the original surface of the object. The cell that includes at least one point is defined as a boundary cell. In the boundary cell, the surface of the object is generated. The reason why the cells are classified into the outer cells and the boundary cells is that the inside and the outside cannot be distinguished from each other since most 3D scanner extracts only the information on the surface of the object. Accordingly, since a cell that is not a boundary cell cannot be determined whether the cell is inside an object or outside the object, both an inner cell and an outer cell are defined as outer cells. Consequently, since such outer cells are inside or outside the object, they cannot contribute to generate surface, and the surface of the object is generated in only the boundary cells including the points. Accordingly, to generate an initial mesh, only the boundary cells are considered.

One boundary cell has six faces, and there are six neighboring cells which the boundary cell meets through the six faces. Some neighboring cells are outer cells and others are inner cells. Accordingly, some of six faces of one boundary cell contacts outer cells and others contacts boundary cells. The face of the boundary cell, which contacts an outer cell, becomes a surface close to the surface of the object. The face through which the boundary cells contact each other can be considered as an inner region of the object. The face through which a boundary cell contacts an outer cell is defined as a boundary face. The approximate surface shape of an object is determined by the boundary cells. Accordingly, the initial mesh of the object is generated by summing all the boundary surfaces.

A boundary cell that includes at least one point from the cell into which the extracted box is uniformly divided at the step 203 is extracted (204). All the boundary surfaces are extracted from all the boundary cells (205). Extracted boundary surfaces are summed to generate the initial mesh (206). The initial mesh is always closed and can be applied to an object of any topology without limitation of topology. Each of the vertexes of a mesh is one of the vertexes of cells. All the surface pieces of the mesh are shaped to be rectangular.

The proceeding process is similar to the conventional method. A continual shrink-wrapping process and a smoothing process are performed. In other words, distances between each vertex constituting a current mesh and all the points are calculated to find the nearest point, and a vertex is moved to the nearest point (207). Here, in the contrast to the conventional method in which all the distances between each vertex and all the points should be calculated, in the present invention, the distances between the points inside the cell to which the vertex belongs and the points inside the twenty-six neighboring cells (six cells contacting the cell to which the vertex belongs through faces, twelve cells contacting the cell to which the vertex belongs through sides, and eight cells contacting the cell to which the vertex belongs through vertexes) only have to be calculated. It is because that each of the twenty-seven cells must include at least one point and the extracted points are identical to shortest distance points obtained from entire points. When the points of shortest distance are determined, the vertex of the mesh should be moved to the points of shortest distance. It makes the initial mesh shrink-wrapped finally. The vertex is moved to any position of a line from a vertex of the original mesh to the nearest point. When the vertex of the mesh to be moved is defined as Vₘₑₛₕ and the nearest point of the vertex is defined as Pₙₑₐᵣₑₛₜ, the movement of the vertex of the mesh is obtained as Equation 3.
νₘₑₛₕ→νₘₑₛₕ+α(pₙₑₐᵣₑₛₜ−νₘₑₛₕ)

Here, coefficient α is a degree of movement and usually 0.5. If α is 1, the vertex of the mesh is immediately moved to the nearest point. Therefore, a plurality of the vertexes may get together to one point or a surface may be overlapped. It can make additional smoothing process difficult. On the contrary, if coefficient α is too small, an initial mesh is converged to the point too slowly and it takes a long time to process. Accordingly, coefficient α is about 0.5 in general. Even if coefficient α is chosen to be a proper value, the several vertexes of the mesh may get together to one point in the region in which comparatively a few points are distributed. It is not desired for the overall mesh performance. It is meaningful that many vertexes are used in the complex surface but it is desirable that the vertexes of the mesh are distributed uniformly on the entire surface in case the complexity of the surface is similar. Accordingly, to relieve the phenomenon that the vertexes get locally together to one point, the mesh smoothing process is performed 208. In the smoothing process, the location of each shrink-wrapped vertex and locations of neighboring vertexes are averaged to move the vertex to the center of the neighboring vertexes as possible. In the smoothing process for the vertex vₘ of an arbitrarily mesh, four neighboring vertexes v_{mbr1}, v_{mbr2}, v_{mbr3} and v_{mbr4} of the vertex are obtained, and the moving vector v_{diff}′ is calculated using the vertexes as equation 4.

$${v}_{diff}^{′} = \frac{1}{4} {\sum }_{j = 1}^{4} ( {v}_{nbrj} - {v}_{m} ) \qquad Equation 4$$

If vₘ is simply moved as much as moving vector V_{mid}, it causes the surface to be shrink-wrapped. In other words, whenever the smoothing process is performed, the overall size of object decreases. Accordingly, a final moving vector v_{diff}′ is obtained as equation 5 so that the vertex is caused to move in a tangential direction of the surface. The vertex vₘ of the mesh is smoothed as equation 5.
ν_{diff}=ν_{diff}′−(ν_{diff}′·n)n
νₘ→νₘ+λν_{diff} Equation 5

Here, n is a normal vector of the vertex vₘ of the mesh, and λ represents smoothing degree. If λ is too large, the more smoothed surface can be obtained but the recess or projecting portions can be modeled unnaturally. If λ is too small, the smoothing effect can be removed. Usually, λ is 0.2-0.4. Therefore, it can relieve the phenomenon that the vertexes of the mesh gets locally together to one point. If the shrink-wrapping process 207 and the smoothing process 208 are repeated as many as a predetermined number by the determination step 209 of repeating the processes, the 3D mesh whose shape approximates to the surface of an object is generated (210). Then, the 3D mesh generation method is completed.

According to a method for generating a 3D mesh by using a shrink-wrapping scheme of boundary cells according to the present invention described above, firstly, each face of an initial minimum bounding box is not divided to generate an initial mesh. The volume consisting of the boxes is divided into cells of a uniform volume to generate initial mesh by using a boundary cell including points of the cells. The initial mesh is shrink-wrapped and smoothed to generate a surface as the conventional method, so that the limitation of the conventional method that can be applied to only Genus-0 spherical topology can be removed. Accordingly, it can be applied to reconstruction of the object having any topology with hole as a doughnut. In the conventional method, all the distances between one vertex and all the points should be calculated to shrink-wrapping one vertex of the mesh. However, since in the present invention, the distances between the points inside the cell to which the vertex of the mesh belongs and the points inside the twenty-six neighboring cells only have to be calculated, the elapsed time for shrink-wrapping process can be amazingly reduced.

It will be apparent to those skilled in the art that various modifications and variations can be made in the present invention. Thus, it is intended that the present invention covers the modifications and variations of this invention provided they come within the scope of the appended claims and their equivalents.

1. A method for generating 3-dimensional mesh, comprising the steps of:
(a) receiving unorganized 3D point coordinates extracted by a 3D scanner or a digitizer;
(b) extracting a minimum bounding box including all the point coordinates and uniformly dividing the extracted bounding box into cells of a predetermined size;
(c) extracting a boundary cell including at least one point from the cells, extracting a boundary surface from all the boundary cells, and generating an initial mesh by summing extracted boundary surfaces;
(d) calculating distances between each vertex constituting the mesh and the several points, finding a nearest point, and moving the vertex to the nearest point; and
(e) averaging location of each shrink-wrapped vertex and locations of the neighboring vertexes, and moving the shrink-wrapped vertex to center of neighboring vertexes.

2. The method of claim 1, wherein when the extracted box extracted at the step (b) is uniformly divided into cells of a predetermined size, a size of cells is set to be smaller where the points are distributed closely so that division precision is proportional to precision of the points.

3. The method of claim 1, wherein, in the step (c), the boundary surface is a surface, which contacts an outer cell including no point among the boundary cells.

4. The method of claim 1, wherein, in the step (d), when distances between each vertex and several points are calculated, only distances between a point inside a cell including the vertex of the mesh and points inside several neighboring cells are calculated.

5. The method of claim 4, wherein the several cells comprise six cells contacting the cell including the vertex of the mesh through faces, twelve cells contacting the cell including the vertex of the mesh through sides, and eight cells contacting the cell including the vertex of the mesh through vertexes.
